(19) United States
(12) Patent Application Publication
(10) Pub. No.: US 2005/0240709 A1
(43) Pub. Date: Oct. 27, 2005

(54) Expansion card

(76) Inventor: Charles N. Shaver, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/829,187

(22) Filed: Apr. 22, 2004

(51) Int. Cl. G06F 13/00

(52) U.S. Cl. 710/313

(57) ABSTRACT

In one embodiment, an expansion card for adding to a computer system a Universal Serial Bus (USB) port is disclosed. The expansion card comprises: an Accelerated Graphics Port (AGP) card connector configured to enable the expansion card to be inserted into an AGP expansion slot of the computer system; and at least one USB port each adapted to mate with a USB-compatible peripheral device, wherein a USB data signal received at the AGP connector is routed to the USB port.

### BACKGROUND

One significant development in the evolution of personal computers is the introduction of the universal serial bus (USB). USB is described in “Universal Serial Bus Specification,” versions 1.1 and 2.0, Compaq Computer Corporation, et al. The USB specification was developed to provide an external expansion bus which facilitates the attachment and removal of peripheral devices to/from a computer. Since its introduction, USB has enjoyed widespread acceptance in the marketplace.

Prior to USB, a personal computer required a separate interface, with specialized electrical, mechanical and software interfaces, to connect to each individual peripheral device. Thus, before the advent of USB, a personal computer required separate interfaces for its keyboard, mouse, monitor, printer, microphone, joy stick, scanner, etc. With USB, USB-capable peripherals can be connected directly to a USB bus of the personal computer without the need for any specialized mechanical, electrical or software interfaces.

Generally, on a USB system, there is one USB host which is typically a personal computer built around a USB-capable motherboard and equipped with USB software. The host acts as the master of the bus, acknowledging attachment and removal of peripherals, initiating enumeration processes and all subsequent USB transactions on the bus, collecting status and activity statistics, and controlling the electrical interface between the host and USB peripherals. USB peripherals act as slaves on the bus and are of two types: “hubs” and “functions.” A “hub” typically consists of a hub controller and a repeater, and usually converts a single upstream attachment port into multiple downstream attachment ports. “Functions” are peripherals such as a keyboard, mouse, camera and the like. A “function” can be self-powered or may derive its power from the USB bus; likewise, a “hub” can be self-powered or bus-powered, to provide power to downstream devices (which may be hubs or functions) attached to its ports.

### SUMMARY

In one aspect of the invention, an expansion card for adding to a computer system a Universal Serial Bus (USB) port is disclosed. The expansion card comprises: an Accelerated Graphics Port (AGP) card connector configured to enable the expansion card to be inserted into an AGP expansion slot of the computer system; and at least one USB port each adapted to mate with a USB-compatible peripheral device, wherein a USB data signal recieved at the AGP connector is routed to the USB port.

In another aspect of the invention, an expansion card is disclosed. The expansion card comprises: a plurality of connectors through which USB data, USB power and power signals are received, wherein each connector is matable with a corresponding connector of the computer system; a plurality of Universal Serial Bus (USB) ports adapted to mate with a USB-compatible device; and circuitry for routing the USB data, USB power and power signals from the plurality of connectors to the USB ports. One of the plurality of connectors is an Accelerated Graphics Port (AGP) card connector configured to enable the expansion card to be inserted into an AGP expansion slot of the computer system.

In a further aspect of the invention, an expansion card is disclosed. The expansion card comprises a plurality of connectors for receiving USB data, USB power and additional power signals, comprising an Accelerated Graphics Port (AGP) card connector configured to enable the expansion card to be inserted into an AGP expansion slot of the computer system; at least one Universal Serial Bus (USB)-Plus-Power port each adapted to mate with a USB-compatible device; and means for routing the USB data, USB power and additional power signals received at the plurality of connectors to the USB-Plus-Power port.

### BRIEF DESCRIPTION OF THE DRAWINGS

FIG. 1 is a block diagram of one embodiment of the AGP expansion card providing USB-Plus-Power ports in accordance with one embodiment of the present invention.

FIG. 2 is a schematic diagram of the AGP connector shown in FIG. 1, illustrating the portion of the AGP interface used in one embodiment of the present invention.

FIG. 3 is a schematic diagram of the USB connector shown in FIG. 1, in accordance with one embodiment of the present invention.

FIG. 4 is a schematic diagram of the power connector shown in FIG. 1, in accordance with one embodiment of the present invention.

FIG. 5 is a schematic block diagram of one embodiment of the voltage doubling circuit illustrated in FIG. 1.

FIG. 6 is a schematic diagram of one embodiment of the signal conditioning illustrated in FIG. 1.

FIG. 7 is a schematic diagram of one embodiment of the detection circuit illustrated in FIG. 1.

FIG. 8 is a diagram illustrating the logic implemented by the detection circuit illustrated in FIG. 7.

FIG. 9 is a diagram illustrating the logic that may be implemented in an alternative embodiment of the detection circuit shown in FIG. 1.

### DETAILED DESCRIPTION

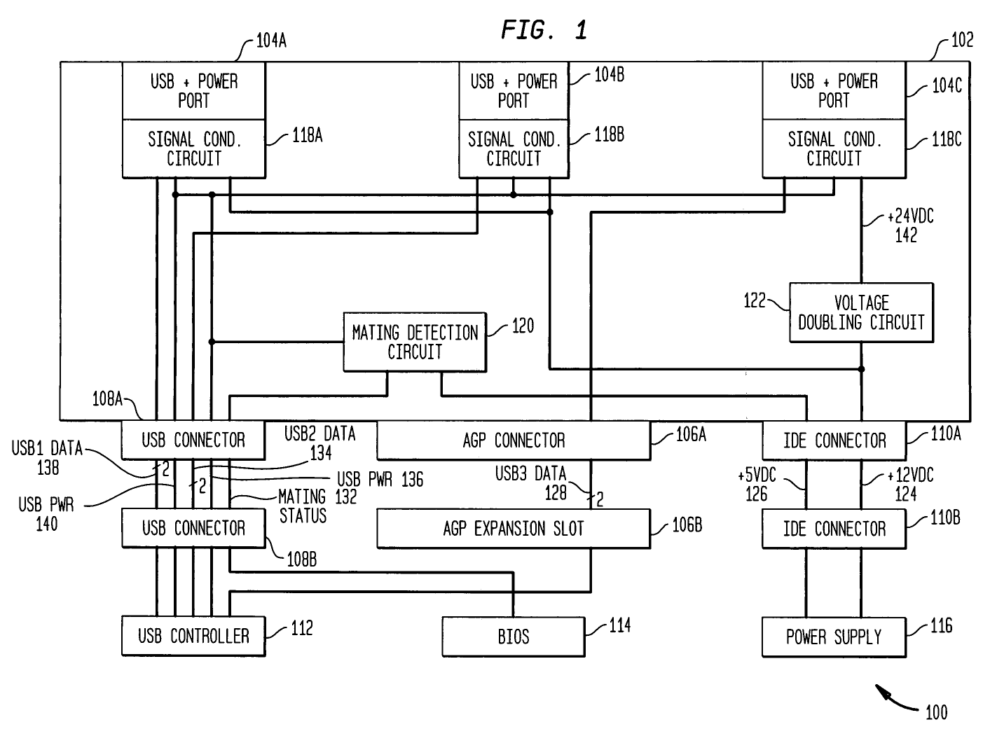

FIG. 1 is a block diagram of one embodiment of an expansion card that provides at least one Universal Serial Bus (USB) port and which can be installed in an Accelerated Graphics Port (AGP) expansion slot of a computer. Expansion card 102 comprises, in this embodiment, three USB-Plus-Power ports 104A, 104B and 104C. USB-Plus-Power ports 104 provide to a connecting USB-compatible device, USB data and USB power signals as well as an additional power signal in accordance with USB Specifications 1.1 and 2.0, and the “PlusPower Electro/Mechanical Application Specific Connector Addendum” (ASCA) to the USB Specifications. The USB specifications and this addendum are hereby incorporated by reference herein.

Each USB-Plus-Power port 104 includes a receptacle that provides a USB data signal and a +5VDC USB power signal. As is well-known in the art, each USB data signal comprises the parallel transmission of two signals: a USB data+signal and a USB data-signal. Each USB-Plus-Power port 104 also includes a separate receptacle that provides additional power to USB devices that require more power than the 5 volts available through a standard USB connector. In this exemplary embodiment, the additional power provided by the power contacts of two USB-Plus-Power ports 104A, 104B is a 12 VDC power signal, while the additional power provided by the power contacts of USB-Plus-Power port 104C is a 24 VDC power signal. It should be appreciated that in alternative embodiments, expansion card 102 can be configured with any quantity and combination of USB ports and/or USB-Plus-Power ports, and that the implemented USB-Plus-Power ports, if any, may provide the same or different voltages.

In accordance with some embodiments of the present invention, expansion card 102 comprises an AGP connector 106A configured to enable the expansion card to be inserted into an AGP expansion slot 106B of computer system 100. As shown in FIG. 1, USB3 data signal 128 is received at AGP connector 106A. The details of an AGP connector utilized in certain exemplary embodiments of the present invention are described below.

In the particular embodiment illustrated in FIG. 1, expansion card 102 also comprises two additional connectors to interface with other components of computer system 100: a power supply connector 110A and a USB connector 108A. Power connector 110A is matable with a corresponding power connector 110B of host computer system 100 through which power from power supply 116 is received. In the embodiment shown in FIG. 1, power connector 110A/110B is an IDE connectors, although other configurations are possible. At power connector 110A, expansion card 102 receives, in one exemplary embodiment, a 5 VDC signal 126 and a 12 VDC signal 124. The details of the power connector 110 utilized in certain exemplary embodiments of the present invention are described below.

In some embodiments of the present invention, USB connector 108A is a standard USB connector matable with a corresponding standard USB connector 108B of computer system 100. In such embodiments, USB connector 108A has two sets of USB contacts. One set of USB contacts carries USB1 data signal 138 while the other set of contacts carries USB2 data signal 134. Two USB power signals 136 and 140 are also provided to expansion card 102 through USB connectors 108A/108B. USB data and power signals 134, 136, 138 and 140 are generated by, for example, a USB controller 112 in computer system 100. In addition, USB connector 108A comprises a contact for providing a mating status signal 132 to computer system 100, as described below.

USB1 data signal 138 is routed to USB-Plus-Power port 104A, while USB2 data signal 134 is routed to USB-Plus-Power port 104B. The two USB power signals 136, 140 are routed to all USB-Plus-Power ports 104A-104C. USB power signal 136 is permanently connected to a 5 VDC source in computer system 100 and is also provided to mating detection circuit 120, as described below. Also, USB power signal 140 is present in certain power states of computer system 100 to provide power to USB-Plus-Power ports 104 so that computer system 100 can be powered/revived via a USB port during certain power states. One embodiment of USB connector 108A is described in detail below.

Associated with each USB port 104A-104C is an optional signal conditioning circuit 118A-118C, respectively. As described in detail below, signal conditioning circuits 118 filter, adjust or otherwise manipulate the signals to be presented at their respective USB-Plus-Power ports 104 to ensure compliance with the appropriate specifications and to maintain signal integrity. One exemplary embodiment of a signal conditioning circuit 118A is described in detail below.

Expansion card 102 has a voltage doubling circuit 122 that converts 12 VDC power 124 received at power connector 110A to 24 VDC power signal 142 for USB-Plus-Power port 104C. As shown in FIG. 1, the 12 VDC power signal 124 is routed to USB-Plus-Power ports 104A, 104B in addition to voltage doubling circuit 122. As a result, the additional power provided by USB-Plus-Power ports 104A and 104B is 12 VDC power while the additional power provided by USB-Plus-Power port 104C is 24 VDC power.

In accordance with certain embodiments of the present invention, expansion card 102 comprises a mating detection circuit 120. Mating detection circuit 120 may determine whether any combination of cable connector(s) and/or card connector(s) is mated with their counterparts in computer system 100. In FIG. 1, for example, mating detection circuit 120 may determine whether cable connectors 108A/108B, cable connectors 110A/110B and/or AGB card connectors 106A/106B are mated; that is, whether the expansion card is installed in computer system 100. In one exemplary embodiment, mating detection circuit 120 detects whether the cable connectors; that is, power connectors 110A/110B and USB connectors 108A/108B, are mated. To make such a determination, mating detection circuit 120 monitors, in one particular implementation, the 5 VDC signal 126 received through power connector 110A and the USB2 power signal 136 received through USB connector 108A.

Mating detection circuit 120 can generate any number of mating status signals each representing the mating status of any desired combination of one or more cable and/or card connectors. The mating status signals is/are provided to other component(s) of computer system 100 for processing to determine the presence and/or integrity of the electrical connections between expansion card 102 and other components of computer system 100. In the embodiment illustrated in FIG. 1, for example, a single mating status signal 132 is provided to computer system 100 via USB connector 108A. In the above-noted example in which mating detection circuit 120 monitors USB connectors 108A/108B and power connectors 110A/110B, mating status signal 132 represents whether both USB connectors 108A/108B and power connectors 110A/110B are mated. The details of various embodiments of detection circuit 120 are described below.

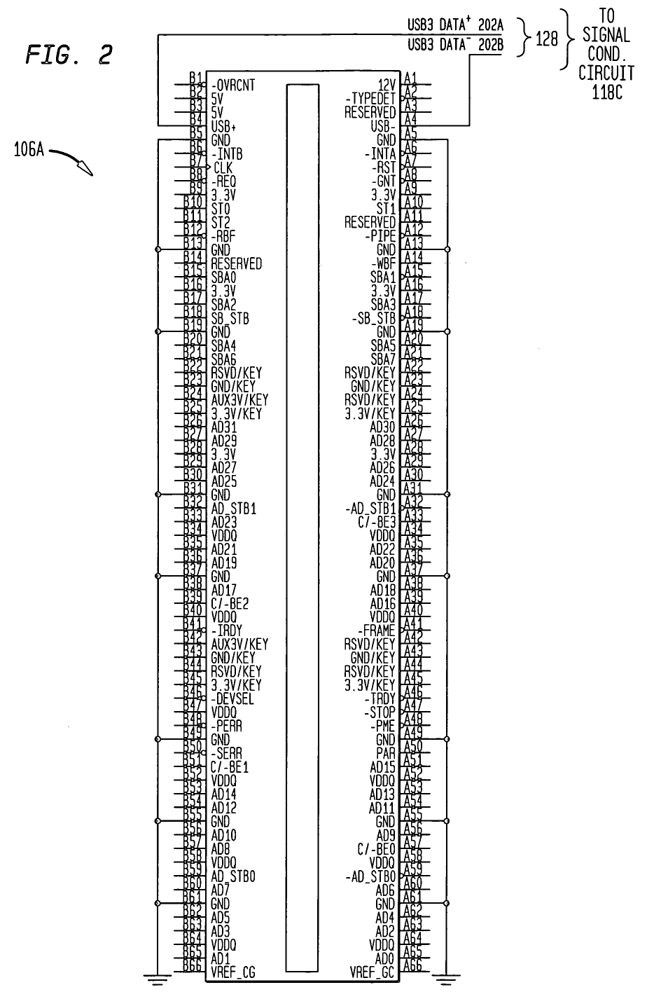

FIG. 2 is a schematic diagram of a standard AGP connector 106A utilized in certain embodiments of the present invention. Of the 132 contacts provided in standard AGP connector 106A, contacts A4 and B4 carry a USB data signal. In the illustrative embodiment, expansion card 102 receives USB3 data+signal 202A and USB3 data—signal 202B at contacts A4 and B4, respectively. It should be appreciated by those of ordinary skill in the art that, USB3 data+signal 202A and USB3 data—signal 202B together comprise USB3 data signal 128 introduced above in connection with FIG. 1. As shown in FIGS. 1 and 2, USB3 data signal 128 is routed to signal conditioning circuit 118C in the particular embodiment of the expansion card 102 illustrated in FIG. 1. Contacts B5, B13, B31, B37, B49, B55, B61, A5, A13, A31, A37, A49, A55 and A61 of AGB connector 106A are grounded in expansion card 102, as shown. All remaining contacts of AGP connector 106A are not used in this particular implementation.

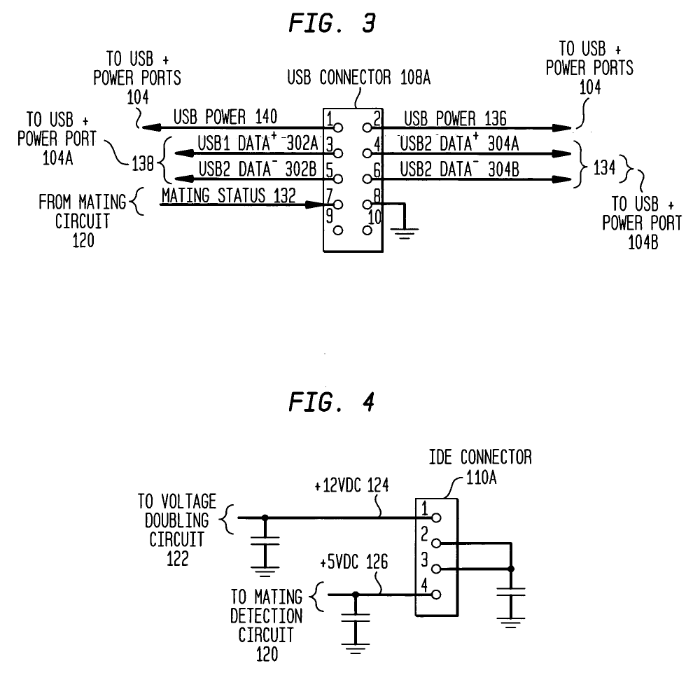

FIG. 3 is a schematic diagram of one exemplary embodiment of USB connector 106A. USB connector 106A is preferably an industry standard, 10-contact, USB connector. Two data lines for USB1 data signal 138; that is, USB1 data+signal 302A and USB1 data—signal 302B, are available at contacts 3 and 5, respectively. Similarly, the two data lines for USB2 data signal 134, USB2 data+signal 304A and USB2 data—signal 304B, are available at contacts 4 and 6, respectively. USB1 data signal 138 is routed to signal conditioning circuit 118A and USB2 data signal 134 is routed to signal conditioning circuit 118A, as described above and as shown in FIGS. 1 and 3.

USB power signals 136 and 140 are provided at contacts 2 and 1, respectively of USB connector 108A. Both USB power signals 136 and 140 are routed to all USB-Plus-Power ports 104, as described above and as shown in FIGS. 1 and 3.

As shown in FIG. 3, contact pin 7 is used to provide mating status signal 132 to computer system 100. As described above and as shown in FIG. 3, mating status signal 132 is generated by mating detection circuit 120. It should be appreciated by those of ordinary skill in the art that in alternative embodiments mating status signal 132 can be routed through another available contact in USB connector 108A. Also, in those embodiments in which more than one mating status signal is generated by mating detection circuit 120, such additional mating status signals can be routed to other available contacts of USB connector 108A.

Of the remaining contacts in USB connector 108A, contact 8 is grounded while contacts 9 and 10 are unused.

FIG. 4 is a schematic diagram of one exemplary embodiment of power connector 110A shown in FIG. 1. In this exemplary embodiment, power connector 110A is a four-contact IDE connector. The noted 12 VDC signal 124 is received at contact 1 while the noted 5 VDC signal 126 is received at contact 4. As shown in FIGS. 1 and 4, 12 VDC signal 124 is routed to voltage doubling circuit 122 and 5 VDC signal 126 is routed to mating detection circuit 120. As shown, one or more capacitors may each be connected between the conductor carrying 12 VDC 124 and 5 VDC 126 signals and a ground potential to filter the received power signals. The remaining two contacts 2 and 3 are grounded.

As one of ordinary skill in the art would find apparent, power connector 110A can have the same or different quantity of contacts, and may have the same or additional contact assignments that that illustrated in FIG. 4. It should also be understood that the power source for the power component of USB-Plus-Power ports 104 may be provided to expansion card 102 via a connector in addition to or other than power connector 110A.

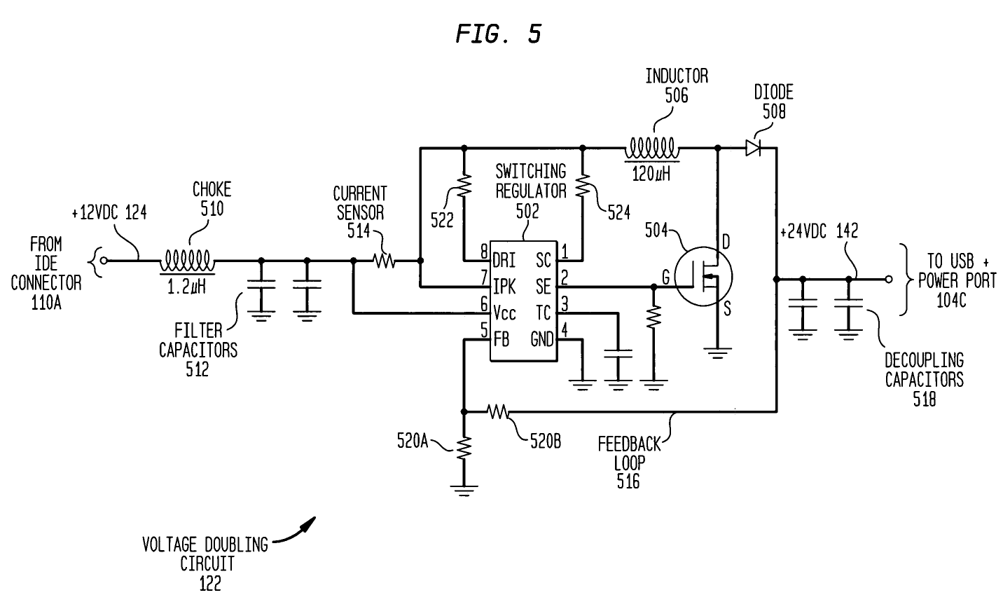

FIG. 5 is a simplified circuit diagram of one embodiment of voltage doubling circuit 122. As noted above with reference to FIG. 1, voltage doubling circuit 122 receives 12 VDC signal 124 from power connector 110A, and generates a 24 VDC signal 142 which is provided, in the embodiment of FIG. 1, to USB-Plus-Power port 104C.

Voltage doubling circuit 122 comprises an inductor 506 connected in series with the anode of a diode 508. The input of inductor 506 is connected to the 12 VDC power signal 124 received from power connector 110A. Inductor 506 stores energy which is delivered to diode 508. The manner in which the energy is delivered to diode 508 is controlled by the state of a FET 504. The drain of FET 504 is connected to the anode of diode 508, and the source of the FET is connected to ground. The gate of FET 506 is connected to a switched output (pin 2) of a switching regulator 502. Switching regulator 502 generates a FET drive signal at its switched output to open and close FET 504 and cyclically alternate the polarity of inductor 506. Cyclically connecting and disconnecting the output of inductor 506 to ground causes a +24 VDC signal to be presented at the cathode of diode 508.

In the embodiment shown in FIG. 5, switching regulator 502 is an NCV33063A switching regulator commercially available from Semiconductor Components Industries, LLC, Phoenix, Ariz., USA. It should be appreciated, however, that other switching regulators can be used. Also, in one embodiment, FET 504 is an FDD5680 N-Channel PowerTrench MOSFET commercially available from Fairchild Semiconductor Corporation, South Portland, Me., USA. It should be appreciated that other components can be used in place of FET 504 depending on the application.

At the input of voltage doubling circuit 122 is a choke 510. Choke 510 is an inductor that filters the switching noise generated by the switching operations performed by voltage doubling circuit 122, preventing such noise from returning to computer system 100 through the power connection 110A/110B. Filtering capacitors 512 may be included in voltage doubling circuit 122 to provide bulk and/or high frequency filtering of +12 VDC signal 124. The 12 VDC power signal 124 is then presented to the drive collector (pin 8) and switch collector (pin 1) of switching regulator 502, respectively. Switching regulator 502 may have appropriate resistors 522, 524 at the drive collector (pin 8) and switch collector (pin 1) to attain proper drive and source control of the implemented switching regulator 502.

Switching regulator 502 is current limiting; that is, it will cease operating when the current of 12 VDC power signal 124 exceeds a predetermined threshold value. Series connected between choke 510 and switching regulator 502 is a current sensing resistor 514. Voltage input (pin 6) and peek current sense input (pin 7) of switching regulator 502 are connected across current sense resistor 514 to monitor the current levels of the signals presented at pins 8 and 1.

Voltage doubling circuit 122 includes a feedback circuit 516 connecting the cathode of diode 508 to a feedback input (pin 5) of switching regulator 502. The voltage presented at the feedback input (pin 5) is determined by a voltage divider circuit comprising resistors 520A and 520B. Switching regulator 502 utilizes such feedback to determine the period of the FET drive signal generated at switch emitter (pin 2) to insure the voltage at the anode of diode 508 is 24.7 VDC and, therefore, the output of voltage doubling circuit 122 is held at 24 VDC.

Decoupling capacitors 518 may be connected between the output conductor of voltage doubling circuit 122 and a ground potential to provide signal decoupling and bulk storage should there be a transient draw at USB-Plus-Power port 104C.

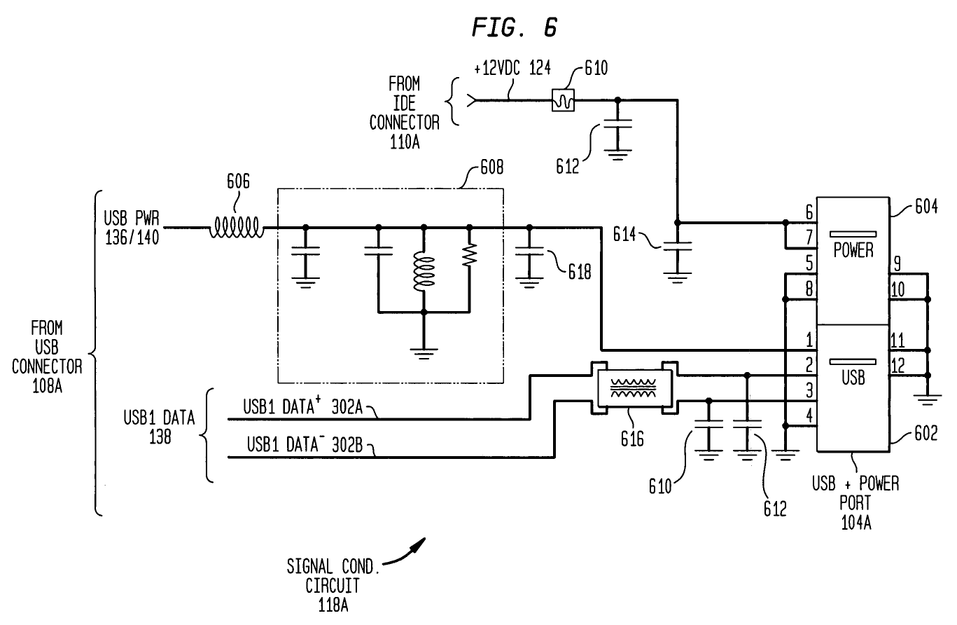

FIG. 6 is a schematic diagram of one embodiment of USB-Plus-Power port 104A and signal conditioning circuit 11 8A illustrated in FIG. 1. As noted, signal conditioning circuit 118 is optional and may not be implemented in certain embodiments of USB port AGP card 102. USB-Plus-Power port 104A comprises a USB receptacle 602 having a set of contacts that provide USB data and power signals to a connecting USB device. Preferably, USB-Plus-Power port 104A is fully compliant with the standard USB Type A host or upstream connector. As shown in FIG. 6, USB receptacle 602 presents USB1 data+signal 302A on pin 2 and USB data—signal 302B on pin 3. USB power signal 140 is presented on pin 1. The remaining pins 4, 11 and 12 are grounded.

In addition, USB-Plus-Power port 104A provides additional power to USB devices that require more power than the +5 volts available at a standard USB connector. This additional power is supplied through a set of contacts contained within a power receptacle 604 of USB-Plus-Power port 104A. As noted, power receptacle 604 is preferably compliant with Application-Specific Connector USB Specification Addendum, which is incorporated by reference above.

In this exemplary embodiment of USB-Plus-Power port 104A, the power provided at power receptacle 604 is 12 VDC. In one alternative embodiment, the power provided at power receptacle 604 may be 24 VDC, similar to USB-Plus-Power port 104C. As shown in FIG. 6, power receptacle 604 presents +12 VDC power signal 124 on pins 6 and 7. The remaining pins 5, 8, 9 and 10 are grounded.

With continued reference to FIG. 6, signal conditioning circuit 118A will now be described. Signal conditioning circuit 11 8A receives USB1 data+signal 302 and USB1 data—signals 302B from USB connector 108A. As noted, USB1 data signals 302A, 302B form USB1 data signals 138, introduced above in connection with FIG. 1.

USB1 data+signal 302A and USB1 data—signal 302B are provided to contacts 2 and 3, respectively, of USB receptacle 602, as noted above. An optional electromagnetic interference (EMI) suppression circuit 616 may be included in signal conditioning circuit 118A to filter electromagnetic interference signals that may be carried on the signal lines that also carry USB1 data signals 302. In addition capacitors 610 and 612 may be included to adjust the rise and fall times of the USB1 data signals 302 as necessary to insure signal integrity at USB receptacle 602.

Signal conditioning circuit 118A also receives USB power signal 140 from USB connector 108A. USB power signal 140 is passed through an inductor 606 and a load circuit 608 to place a small load on the circuit to ensure power supply 116 remains stable. A capacitor 618 may be connected between the conductor carrying USB power signal 140 and ground to filter high frequency noise carried on the signal conductor that also carries USB power signal 140.

As noted, power receptacle 604 provides a power signal to a device connected to USB-Plus-Power port 104A. As shown in FIGS. 1 and 3, +12 VDC power signal 124 is provided to signal conditioning circuit 118A from power connector 110A. As noted above with reference to FIG. 6, the 12 VDC power signal 124 is provided to contacts 6 and 7 of power receptacle 604. Signal conditioning circuit 118A includes an optional fuse 610 through which +12 VDC power signal 124 passes before being presented at contacts 6 and 7. Fuse 610 opens if the current level of +12 VDC power signal 124 exceeds some predetermined threshold value.

A capacitor 612 may be connected between the conductor carrying +12 VDC power signal 124 and ground. Capacitor 612 provides bulk decoupling of devices connected to USB-Plus-Power port 104A to insure power is continually provided to such a connected device under conditions of a heavy transient power draw. A second, smaller capacitor 614 may also be connected between the conductor carrying +12 VDC power signal 124 and ground to provide signal filtering of +12 VDC power signal 124 prior to the power signal being presented at contacts 6 and 7 of power receptacle 604.

Expansion card 102 comprises, as noted, a mating detection circuit 120 that detects whether one or more selected connectors 106A, 108A, 110A of the expansion card are mated with the corresponding connectors. That is, mating detection circuit 120 determines whether USB connector 106A is mated with USB connector 106B; power connector 110A is mated with power connector 110B; and/or AGB connector 106A is mated with AGB expansion slot 106B. One or more signals provided by, derived from or controlled by signals received at connectors 106A, 108A and/or 110A is/are monitored by mating detection circuit 120 to make such determination(s). Mating detection circuit 120 generates at least one signal each representing whether a selected combination of one or more connectors 106A/106B, 108A/108B and/or 110A/110B is/are mated.

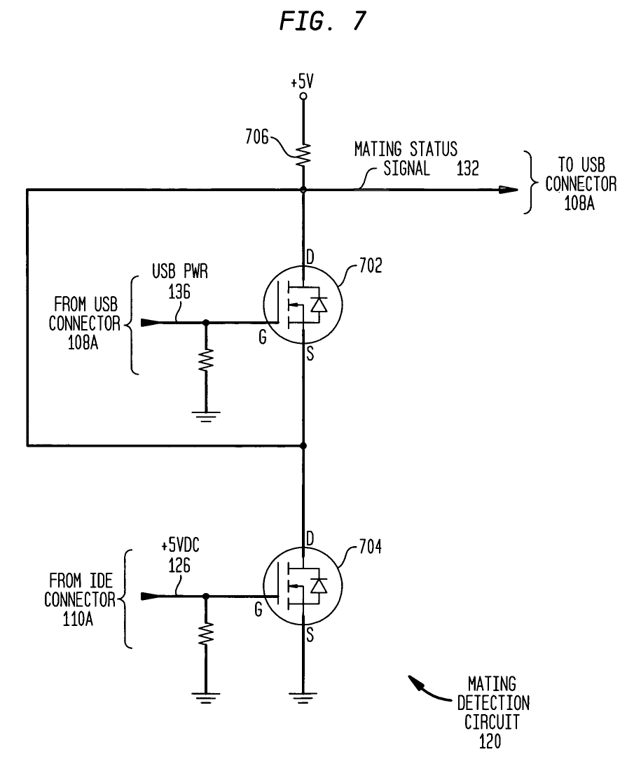

As shown in FIG. 7 and as introduced above in connection with FIG. 1, the embodiment of mating detection circuit 120 shown in FIG. 1 generates a single output signal, mating status signal 132, indicating whether both, USB connectors 106A/106B and power connectors 110A/110B, are mated. The absence of mating status signal 132 indicates either that one of the two connectors 106A/106B or 108A/108B are not mated, or that USB port AGB expansion card 102 is not installed. It should be appreciated that in alternative embodiments, mating detection circuit 120 can generate more than one status signal each representing the mating status of any combination of one or more connectors 106, 108 and 110. This is described in further detail below.

Mating detection circuit 120 provides mating status signal 132 to other components of computer system 100 for monitoring. In the embodiment illustrated in FIG. 1, mating status signal 132 is provided to BIOS 114 via USB connector 108A. It should be appreciated, however, that in alternative embodiments such information can be provided to computer system 100 via any data transmission capability in host computer system 100. In the embodiment illustrated in FIG. 1, BIOS 114 of computer system 100 monitors the one or more mating status signals 132 during BIOS POST operations. Accordingly, mating status signal 132 controls the status of one or more bits in any location in computer system 100 that is accessible to BIOS 114. In one embodiment, for example, mating status signal 132 controls the state of a general purpose I/O (GPIO) bit.

FIG. 7 is a schematic diagram one exemplary embodiment of mating detection circuit 120. As noted, in this embodiment, mating detection circuit 120 detects whether USB connector 108A and power connector 110A are mated with their corresponding connectors. In this particular embodiment, mating detection circuit 120 directly monitors signals received at connectors 108, 110. Specifically, +5V USB power signal 140 received at USB connector 108 and +5 VDC power signal 126 received at power connector 110 are monitored by mating detection circuit 120. Both signals drive the gate of an associated FET. Specifically, USB power signal 140 drives the gate of a FET 702 while +5 VDC power signal 126 drives the gate of a FET 704. FETs 702, 704 are arranged in series, with the source of FET 702 connected to the drain of FET 704. The drain of both FETs 702, 704 is connected to a +5 VDC source through a pull-up resistor 706. Because this embodiment of expansion card 702 does not have its own source of power, the source of the +5V pull-up voltage is received from an external source. This +5V power could be obtained from any available source in computer system 100. Mating status signal 132 is provided at the drain of FET 702. Mating status signal 132 is held at +5V unless expansion card 102 is not installed in computer system 100, or, the expansion card is installed at least one of the USB connector 108A and power connector 110A are not mated with their respective counterpart connectors 108B and 110B.

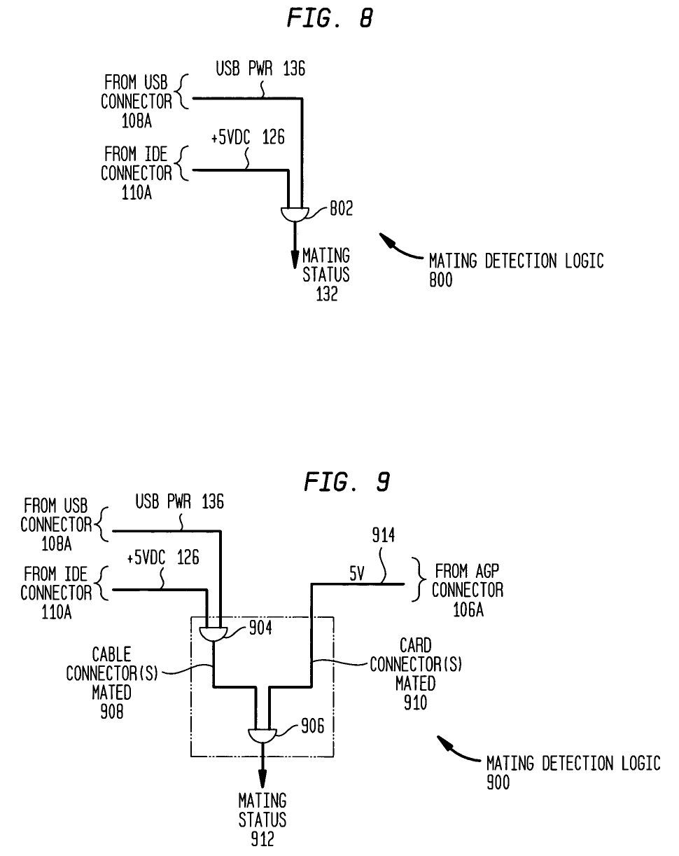

A logical representation of the operation performed by the above embodiment of mating detection circuit 120 is shown in FIG. 8. Essentially, mating detection circuit 120 implements an “AND” logic function 802, generating a mating status signal 132 when both USB power signal 140 and +5 VDC power signal 126 are present. However, alternative embodiments of mating detection circuit 120 may generate one or more mating status signals each representing whether a selected combination of one or more connectors is mated. One example is shown in the logic diagram of FIG. 9. Mating detection logic 900 implements two “AND” functions. AND gate 904 receives the USB power signal 140 from USB connector 108A and 5 VDC signal 126 from power connector 110A, and generates a cable connector(s) mated signal 908 when both of the connectors 108, 110 are mated.

Mating detection logic 900 also receives another signal directly or indirectly from, or controlled by, AGB connector 106A. The presence of this signal indicates that the card connector(s) are mated, as indicated by signal 910. Mating detection logic 900 implements another AND function 906, generating a mating detection status signal 912 when both, the cable connector(s) status signal 908 and the card connector(s) status signal 910 are present.

It should be appreciated by those of ordinary skill in the art that in an alterative embodiment cable connector(s) mated signal 908 and/or card connector(s) mated signal 910 may be generated as output signals similar to mating status signal 912. In such an embodiment all three signals may control individual GPIO bits which are readable by BIOS 114. Such an embodiment may facilitate the diagnosis of an inoperable USB port AGB expansion card 102.

As noted, embodiments of mating detection circuit 120 can monitor any signal provided by, derived from or controlled by connectors 106, 108 and/or 110. For example, the +5Vdc signal 914 monitored in the embodiment illustrated in FIG. 4 can be generated by a circuit when that circuit detects the presence of a ground signal from AGP connector 106A. Alternatively, the signal can be received directly from AGP connector 106A. It should be appreciated by those of ordinary skill in the art that many types of signals can be monitored directly, or used to generate signal that may be monitored by a mating detection circuit as described elsewhere herein.

It should be appreciated that expansion card 102 enables USB ports and/or USB-Plus-Power ports to be added to a computer system without consuming other valuable resources of the computer system, such as a PCI (Peripheral Component Interconnect) slot, and without having to redesign or add internal circuit boards to provide, for example, voltage doubling circuit 122.

It should also be appreciated that implementation of a mating detection circuit such as that described above provides a simple way for a computer system to automatically detect the presence of an expansion card during the manufacturing process. For example, during manufacturing assembly, the proper and complete installation of expansion card 102 would otherwise be determined by manually connecting a high-powered USB peripheral device to one of the card's USB Plus-Power ports 104. The detection circuit eliminates the labor and delay associated with such an approach.

Although embodiments of the present invention have been fully described in conjunction with the preferred embodiment thereof with reference to the accompanying drawings, it is to be understood that various changes and modifications may be apparent to those skilled in the art. For example, in the above embodiments, expansion card 102 provides three USB Plus-Power ports 104. In alternative embodiments, expansion card 102 provides a fewer or greater quantity of USB Plus-Power ports 104. As another example, USB ports 104 are USB Plus-Power ports, as described above. The operating voltage transmitted through the universal serial bus is limited to 5 volts. This limits the power that can be consumed by peripherals connected on a universal serial bus. The USB Plus-Power ports 104 implemented in the above embodiment of expansion card 102 provides additional power to USB devices that require power not available through the standard USB ports. It should be appreciated, however, that not all USB ports provided on an AGB expansion card 102 may provide such additional power, and that universal USB ports can be implemented in addition to or in place of the noted USB Plus-Power ports 104. As a further example, detection circuit 120 is implemented on expansion card 102 in the above-described embodiments. In alternative embodiments, mating detection circuit 120 may be implemented in any other component of compute system 100. In a further example, the embodiment of the AGP expansion card 102 includes a voltage doubling circuit 122 to provide +24 VDC to one USB Plus-Power port 104C. The voltage doubling circuit 122 will not easily fit on the motherboard of computer system 100 so implementing the circuit on AGB expansion card 102 makes available the +24 VDC to USB devices while not requiring significant redesign of the motherboard or the design of a dedicated daughter card. However, it should be appreciated that a USB Plus-Power port 104 that provides +24 VDC may not be implemented in alternative embodiments. Similarly, all USB-Plus-Power port(s) 104 implemented on alternative embodiments of expansion card 102 can provide +24 VDC or no ports may provide +12 VDC. While not implemented on the expansion cards described above, a USB hub can be implemented in expansion card 102 to expand the number of USB ports. Such an embodiment may be desirable, for example, if USB data signals 134, 138 are not available. In such an embodiment, USB3 data signals present on AGP connector 106A may be attached to a USB hub on expansion card 102. The additional power signal may also be obtained from AGP connector 106 if the current draw is not excessive for such a card connector. Alternatively, the additional as well as the USB power can be obtained from power connector 110A, if available. The USB hub would expand the number of USB ports available on the expansion card. Such changes and modifications are to be understood as included within the scope of the present invention as defined by the appended claims.

1. An expansion card for adding to a computer system a Universal Serial Bus (USB) port, comprising:
an Accelerated Graphics Port (AGP) card connector configured to enable the expansion card to be inserted into an AGP expansion slot of the computer system; and
at least one USB port each adapted to mate with a USB-compatible peripheral device,
wherein a USB data signal received at the AGP connector is routed to the USB port.

2. The expansion card of claim 1, wherein one or more of the at least one USB port is a USB-Plus-Power port comprising a USB receptacle at which a USB data signal and a USB power signal are presented, and a power receptacle at which a power signal is presented to a mated USB-compatible peripheral device.

3. The expansion card of claim 1, wherein the expansion card further comprises:
a USB connector, matable with a corresponding USB connector of the computer system, at which at least one additional USB data signal and at least one USB power signal generated by the computer system are received,
wherein each of the additional USB data signal and USB power signal is routed to one or more of the at least one USB port.

4. The expansion card of claim 2, wherein the expansion card further comprises:
a power connector, matable with a corresponding power connector of the computer system, through which the power signal is received,
wherein the power signal is routed to at least one of the one or more USB-Plus-Power ports.

5. The expansion card of claim 4, wherein the additional power signal is a 12 VDC power signal.

6. The expansion card of claim 1, wherein the expansion card further comprises:
at least one circuit each associated with one of the at least one USB port, wherein each circuit performs signal conditioning operations on at least one signal provided at its associated USB port.

7. The expansion card of claim 5, wherein the expansion card further comprises:
a circuit configured to convert the 12 VDC power signal to a 24 VDC power signal,
wherein the 24 VDC power signal is routed to one or more of the at least one USB-Plus-Power ports.

8. The expansion card of claim 1, wherein the USB power signals are routed to all USB-Plus-Power ports.

9. The expansion card of claim 4, wherein the voltage doubling circuit comprises:
a diode having an anode and a cathode;
an inductor connected in series between the diode anode and the power signal received from the power connector;
a FET having a drain and source respectively connected to the diode anode and ground; and
a switching regulator having an input at which the power signal is received, and a switched output connected to a gate of the FET at which a FET drive signal is produced to cyclically alternate the polarity across the inductor.

10. The expansion card of claim 9, wherein the voltage doubling circuit further comprises:
a feedback circuit connecting the diode cathode to a feedback input of the switching regulator, wherein the switching regulator determines a period of the FET drive signal based on a voltage received at the feedback input.

11. An expansion card comprising:
a plurality of connectors through which USB data, USB power and power signals are received, wherein each connector is matable with a corresponding connector of the computer system;
a plurality of Universal Serial Bus (USB) ports adapted to mate with a USB-compatible device; and
circuitry for routing the USB data, USB power and power signals from the plurality of connectors to the USB ports,
wherein one of the plurality of connectors is an Accelerated Graphics Port (AGP) card connector configured to enable the expansion card to be inserted into an AGP expansion slot of the computer system.

12. The expansion card of claim 11, wherein at least one of the plurality of USB ports is a USB-Plus-Power port comprising a USB receptacle at which USB data and USB power signals are presented, and a power receptacle at which a power signal is presented.

13. The expansion card of claim 11, wherein the plurality of connectors further comprises:
a USB connector, matable with a corresponding USB connector of the computer system, at which at least one USB data signal and at least one USB power signal are received.

14. The expansion card of claim 12, wherein the plurality of connectors further comprises:
a power connector, matable with a corresponding power connector of the computer system, through which a power signal is received.

15. The expansion card of claim 11, wherein the additional power signal is a 12VDC power signal.

16. The expansion card of claim 11, wherein the expansion card further comprises:
a signal conditioning circuit constructed and arranged to perform signal conditioning operations on at least one signal to be provided to at least one of the plurality of USB ports.

17. The expansion card of claim 12, wherein the power signal presented at the power receptacle of at least one of the USB-Plus-Power ports is a 12 VDC power signal, and wherein the expansion card further comprises:
a circuit configured to convert the 12 VDC power signal to a 24 VDC power signal, wherein the 24 VDC power signal is routed to one or more of the at least one USB-Plus-Power ports.

18. The expansion card of claim 17, wherein the circuit comprises:
a diode having an anode and a cathode;
an inductor connected in series between the diode anode and the power signal received from the power connector;
a FET having a drain and source respectively connected to the diode anode and ground; and
a switching regulator having an input at which the power signal is received, and a switched output connected to a gate of the FET at which a FET drive signal is produced to cyclically alternate the polarity across the inductor.

19. The expansion card of claim 18, wherein the circuit further comprises:
a feedback circuit connecting the diode cathode to a feedback input of the switching regulator, wherein the switching regulator determines a period of the FET drive signal based on a voltage received at the feedback input.

20. An expansion card comprising:
a plurality of connectors for receiving USB data, USB power and additional power signals, comprising an Accelerated Graphics Port (AGP) card connector configured to enable the expansion card to be inserted into an AGP expansion slot of the computer system;
at least one Universal Serial Bus (USB)-Plus-Power port each adapted to mate with a USB-compatible device; and
means for routing the USB data, USB power and additional power signals received at the plurality of connectors to the USB-Plus-Power port.

21. The expansion card of claim 20, wherein one or more of the at least one USB-Plus-Power port comprises a USB receptacle at which a USB data signal and a USB power signal are presented, and a power receptacle at which a power signal is presented.

22. The expansion card of claim 20, wherein the expansion card further comprises:
a USB connector, matable with a corresponding USB connector of the computer system, at which at least one additional USB data signal and at least one USB power signal generated by the computer system are received,
wherein each of the additional USB data signal and USB power signal is routed to one or more of the at least one USB port.

23. The expansion card of claim 22, wherein the expansion card further comprises:
a power connector, matable with a corresponding power connector of the computer system, through which an additional power signal is received,
wherein the additional power signal is routed to at least one of the one or more USB-Plus-Power ports.

24. The expansion card of claim 23, wherein the additional power signal is a 12 VDC power signal.

25. The expansion card of claim 20, wherein the expansion card further comprises:
at least one circuit each associated with one of the at least one USB-Plus-Power port, wherein each circuit performs signal conditioning operations on signals to be provided at its associated USB-Plus-Power port.

26. The expansion card of claim 24, wherein the expansion card further comprises:
a circuit configured to convert the 12 VDC power signal to a 24 VDC power signal,
wherein the 24 VDC power signal is routed to one or more of the at least one USB-Plus-Power ports.
